(19) United States
(12) Patent Application Publication
(10) Pub. No.: US 2020/0410138 A1
(43) Pub. Date: Dec. 31, 2020

(54) DATA STORAGE SYSTEM WITH DEVICE PROVENANCE

(71) Applicant: Seagate Technology LLC, Fremont, CA (US)

(72) Inventor: Christopher Nicholas Allo, Longmont, CO (US)

(21) Appl. No.: 16/946,477

(22) Filed: Jun. 24, 2020

Related U.S. Application Data
(60) Provisional application No. 62/868,287, filed on Jun. 28, 2019.

(51) Int. Cl. G06F 21/73; G06F 3/06; H04L 9/32; G06F 21/60; G06F 21/62; G06F 21/64; G06F 21/44

(52) U.S. Cl. CPC G06F 21/73; G06F 3/0622; G06F 3/0659; G06F 3/0673; G06F 21/44; G06F 21/606; G06F 21/62; H04L 9/3236; G06F 21/64; H04L 9/3263

(57) ABSTRACT

A data storage system can provide device provenance with a storage device encoded with a key certificate and initialized into a distributed data system. A handshake module of the data storage device may derive a secure identifier and a provenance module of the data storage device can monitor data storage device activity to maintain an in-device provenance. A trusted data pathway between the data storage device and a host of the distributed data storage system can be formed with the secure identifier.

### RELATED APPLICATION

The present application claims priority to U.S. Provisional Patent Application No. 62/868,287 filed Jun. 28, 2019, the contents of which is hereby incorporated by reference.

### SUMMARY

A data storage system, in accordance with various embodiments, has a storage device encoded with a key certificate and initialized into a distributed data system. A handshake module of the data storage device derives a secure identifier and a provenance module of the data storage device monitors data storage device activity to maintain an in-device provenance. A trusted data pathway between the data storage device and a host of the distributed data storage system is formed with the secure identifier.

In some embodiments, a data storage system encodes a storage device with a key certificate and initializes the data storage device into a distributed data system. A secure identifier is derived with a handshake module of the data storage device and data storage device activity is monitored with a provenance module of the data storage device to maintain an in-device provenance. The secure identifier is utilized to form a trusted relationship with a host of the distributed data storage system.

Other embodiments of a data storage system encode a storage device with a key certificate and initialize the data storage device into a distributed data system. A secure identifier is derived with a handshake module of the data storage device and data storage device activity is monitored with a provenance module of the data storage device to maintain an in-device provenance. The secure identifier is utilized to form a trusted relationship with a host of the distributed data storage system before an imminent detachment of the data storage device from the distributed data system is detected and the secure identifier is removed as a requirement for data storage device access and control with the handshake module.

### BRIEF DESCRIPTION OF THE DRAWINGS

FIG. 1 is a block representation of an example data storage system in which assorted embodiments can be practiced.

FIG. 2 depicts a block representation of portions of an example data storage system operated in accordance with some embodiments.

FIG. 3 depicts portions an example data storage system configured in accordance with various embodiments.

FIG. 4 depicts portions of an example data storage device that may be employed in the data storage systems of FIGS. 1-3.

FIG. 5 depicts an example portion of a data storage device configured and operated in accordance with assorted embodiments.

FIG. 6 depicts an example portion of a data storage device utilized in accordance with some embodiments.

FIG. 7 provides a flowchart of an example in-device provenance routine carried out in accordance with assorted embodiments.

### DETAILED DESCRIPTION

Embodiments of the present disclosure are generally directed to a data storage system that employs storage device provenance to optimize the secure connection between a storage device and a host in a distributed computing network.

As the volume of data being generated and transferred has increased, computing systems have attempted to keep pace by providing greater data capacity, faster data access speed, and reduced boot times. While data storage, and distribution, devices have become more sophisticated to accommodate larger volumes of data, the security of the data being transferred, stored, and retrieved has not advanced to the point where data can be securely moved and stored without sacrificing data storage performance. Hence, there is a continuing goal to provide increased security in a data storage system with heightened efficiency and reliability that does not degrade overall data storage system performance.

Accordingly, various embodiments are directed to a data storage device that employs provenance and handshake modules to provide secure storage device connection to a distributed data system and secure data authentication of the device's trustworthiness. The ability to efficiently maintain a secure connection for a storage device without jeopardizing data storage, or system, performance provides optimal operation over time.

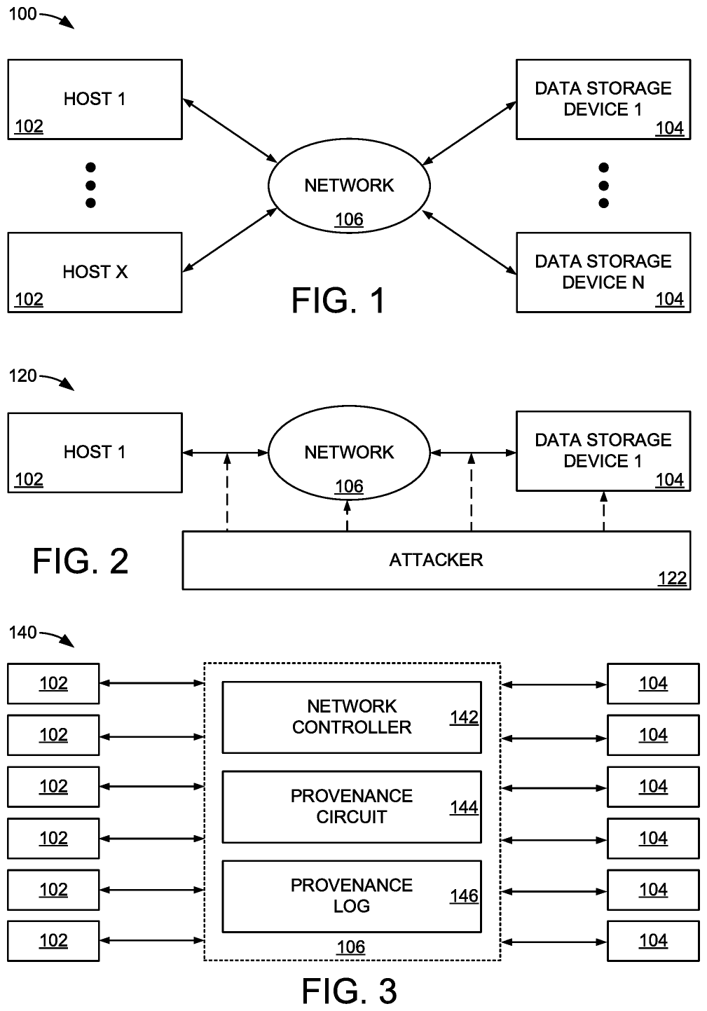

Turning to the drawings, FIG. 1 depicts a block representation of an example distributed data storage system 100 in which assorted embodiments can be practiced. The system 100 can connect any number (X) of hosts 102 with any number (N) of data storage devices 104 via a network 106. A host 102 can be any generator of a data access request, such as processor, controller, virtual machine, app container, or software, connected to the data storage devices(s) 104 via one or more wired, and/or wireless, signal pathways.

A data storage device 104 may be any data receptacle that employs a non-volatile memory, such as a rotating magnetic media, solid-state array, or a combination thereof. It is contemplated that multiple data storage devices 104 are physically positioned within a single rack with some network 106 equipment, such as a server or switch. Such condensed physical footprint for multiple data storage devices 104 can provide efficient physical access and large data capacity, but can suffer from performance bottlenecks within a data storage device 104 and/or network 106 equipment.

The condensing of signal pathways through network 106 equipment, regardless of the physical location of the respective data storage devices 104, can create a security bottleneck where third-party attackers can attain large volumes of system 100 information and data. The securing of network 106 equipment currently takes relatively large volumes of computing power and processing that results in degraded data storage performance compared to if no security measures were present. Thus, a system 100 administrator has, in the past, had to choose between heightened security and slower data storage performance or lower security with heightened data storage performance.

FIG. 2 depicts a block representation of a portion of an example data storage system 120 where a third-party attacker 122 is attempting to nefariously infiltrate. As shown by segmented lines, the attacker 122 can attempt to enter the data storage system 120 at several different locations, such as upstream of network 106 distribution, downstream of network 106 distribution, and at a data storage device 104 itself. An attack by the attacker 122 may take many different forms that are directed to copying, altering, or hijacking data, commands, and/or other information that allows the attacker 122 to access and/or control portions of the system 120 in the future.

In a non-limiting example, an attacker 122 can initially gain system 120 information that allows for future access to firmware of the data storage device 104 where the attacker 122 can manipulate control, security policies, and other administrative functions that compromise the integrity and reliability of data stored in the data storage device 104 as well as other connected devices 104 of the system 120. Another example attack results in providing the attacker 122 with trusted status that allows access to existing and future data. These attacks are in no way limiting, but illustrate how an attacker 122 can infiltrate and compromise an entire data storage system 120 with mere access to relatively small portions of the system 120.

With the risk to data, data storage devices, and network nodes posed by third-party attackers 122, attempts have been made to provide heightened network security through the tracking of data. FIG. 3 depicts a block representation of portions of an example data storage system 140 where heightened security measures are conducted in accordance with some embodiments. The storage system 140 can employ one or more network controllers 142 that direct distribution of data and data access requests between various hosts 102 and data storage devices 104. The network controller 142 can conduct various security operations that can establish and/or maintain a trusted, secure data connection.

In some embodiments, the network controller 142 can activate a provenance circuit 144 that polls, tests, and authenticates the data stored in a data storage device 104, or requested by a host 102. Such activity can be characterized as data provenance and can be carried out initially when data is introduced to the system 140 and anytime thereafter, such as in response to a potential attack by a third party. Such data provenance can result in a provenance log 146 tracking the history of data from various trusted devices 104 and hosts 102.

The provenance circuit 144 may additionally conduct activities that authenticate storage devices 104, network equipment, and/or hosts 102. This device provenance can result in the log 146 tracking the history of initializations, firmware versions, and/or encryption keys. The ability to track the provenance of data and/or devices of the system 140 can provide robust security that quickly recognizes attempted and successful third-party attacks. However, the tracking of data and/or device metrics that allow for provenance generation and secure data/device authentication can be quite complex, time consuming, and processing heavy, which can degrade at least the data storage performance of portions of the system 140.

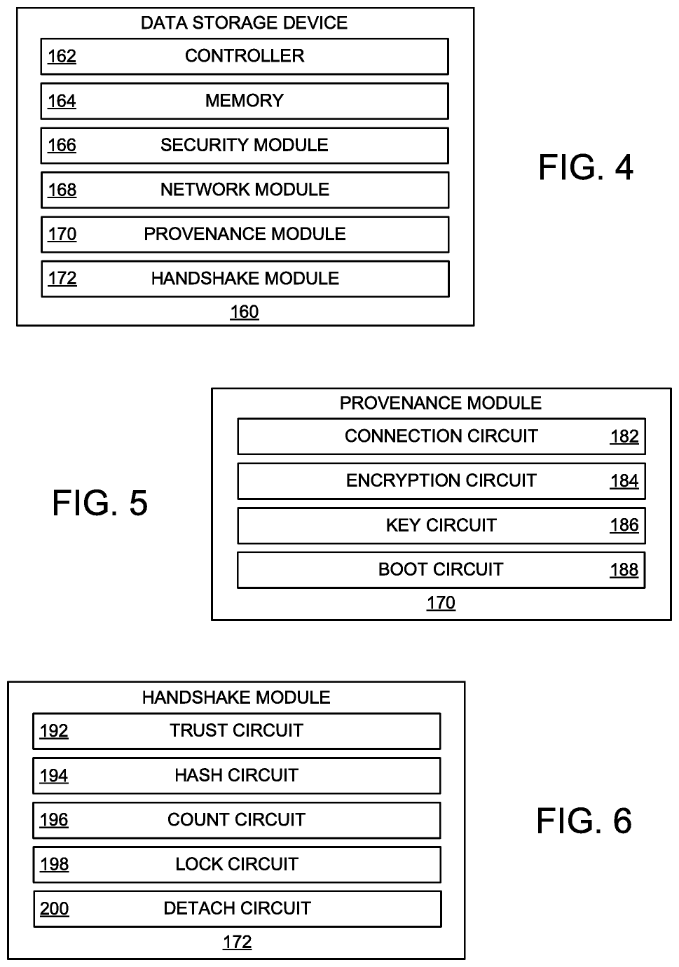

Accordingly, various embodiments utilize in-device provenance that tracks secure connections instead of data or device metrics to authenticate the operation of the system 140 as secure. FIG. 4 depicts a block representation of an example data storage device 160 that can be utilized in the data storage systems of FIGS. 1-3. The device 160 can employ one or more controllers 162, which may be local or remote tot the device 160, to direct operations of the various hardware and software configured to carry out data storage and retrieval. A device controller 162 can temporarily, or permanently store data in a local memory 164 that pertains to the administration of at least security, provenance, and secure system connection operations.

It is contemplated that security operations can be carried out by a security module 166, system connectivity is carried out by a network module 168, connection provenance is carried out by a provenance module 170, and securing system connections is carried out by a handshake module 172. The respective modules 166/168/170/172 can be resident in hardware and/or software of the data storage device 160, which can increase efficiency and reliability compared to accessing modules resident in a remote system location, such as a network controller.

FIG. 5 depicts a block representation of an example provenance module 170 that can be utilized in one or more data storage devices connected in a distributed data storage system. The provenance of a data storage device can be established and authenticated by counting the number of times the device has been connected to a system since the device was created. The detection and tracking of system connections via at least a connection count can be conducted by a connection circuit 182.

The provenance module 170 can encode data, information, software, and firmware of a device with an encryption circuit 184 that executes one or more encryption techniques in combination with a key circuit 186 to generate a unique device key that is a derivative of a unique key certificate assigned to the data storage device during fabrication and testing while in the custody of a manufacturer. In some embodiments, the unique key certificate, derived device key, and/or connection count can be employed by a boot circuit 188 to efficiently startup and initialize a data storage device after an intentional or unintentional power cycle or reset.

As a result of the operations of the provenance module 170, knowledge of the storage device history can be efficiently tracked and verified to provide a network with provenance information that certifies the device is, and has been continually, secure throughout its service life. The generation of provenance verification at the device level, compared to the network level, is increasingly efficient while providing robust security and reliability. In yet, the generation and maintenance of device and constituent data provenance merely tracks activity and does not prevent third-party attacks from invading, or at least threatening, data storage system integrity and performance.

The prevention of third-party attacks can, however, be conducted with the handshake module 172, which is depicted as a block representation in FIG. 6. A trust circuit 192 can be utilized by the handshake module 172 to monitor the relationship of hosts and network equipment that are requesting access to a data storage device. The trust circuit 192 can conduct continuous, or sporadic, tests, polling, and/or verifications to establish a trust relationship between a storage device and a system, which eliminates any need for external device verification of a key, signature, or encryption code.

Much like the encryption circuit 184 of the provenance module 170, the handshake module 172 can employ a hash circuit 194 that conducts hash functions with the device key and the system trusted platform module (TPM) to derive a secure identifier that indicates the storage device, and connection are paired and secure. The secure connection can then be counted by a count circuit 196. The secure connection count enables a lock circuit 198 to conduct protection policies that prevent unwanted system access from third parities. For example, the lock circuit 198 can prevent any storage device access from any host besides the network controller, or direct host, secured by the hash 194 and trust 192 circuitry.

As another non-limiting example, the lock circuit 198 can ensure that the storage device is not reused, or reconnected, unless it is properly detached from the secured connection, which requires correct knowledge of the internal storage key for the storage device. As such, the handshake module 172 consists of a detach circuit 200 that can operate with the lock circuit 198 to remove a secure connection and allow future connections to be established. It is contemplated that multiple secure connections can be concurrently operating from a storage device, but such configuration is not required or limiting.

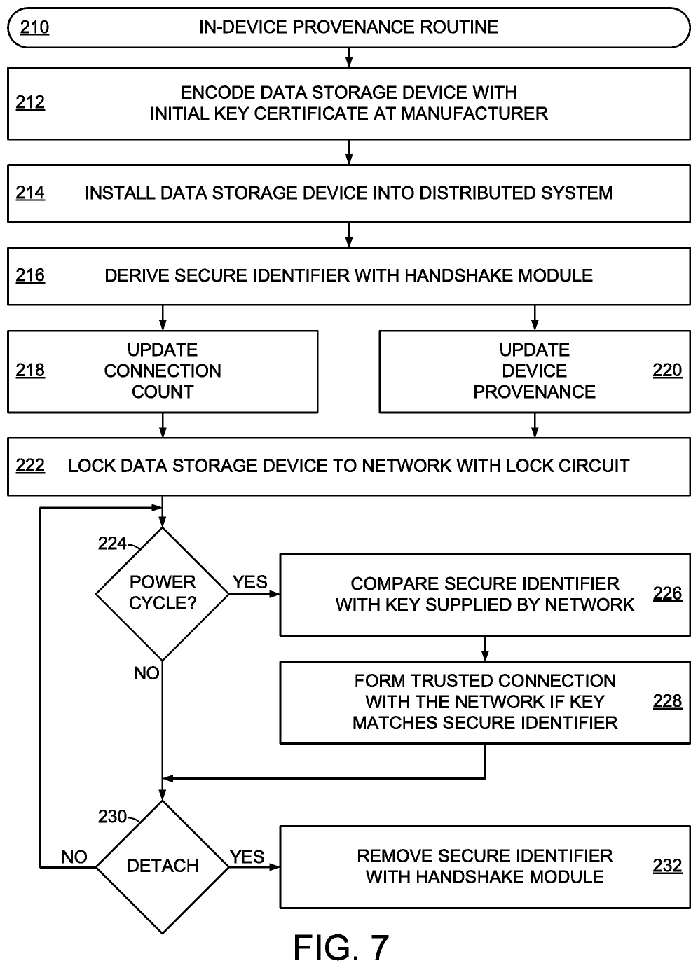

FIG. 7 depicts an example in-device provenance routine 210 that can be carried out with various embodiments of FIGS. 1-6 to provide a data storage system with continuously accurate provenance and secure data connections. Initially, a data storage device can be fabricated and tested by a manufacturer to produce a device that is capable of being immediately used by an end-user, such as a business or individual consumer. At the conclusion of the fabrication and testing at the manufacturer, step 212 encodes the data storage device with an initial key certificate that is unique to that data storage device. The key certificate is not limited, but may incorporate one or more unique device characteristics, such as serial number, tested read latency, or measured fly height, into a single certificate that would be impossible to recreate without knowledge of the manufacturing and/or testing data.

Once the data storage device is shipped from the manufacturer, an end-user installs the device into a distributed data storage system in step 214. It is noted that a data storage device is not limited to installation in a distributed system and may be connected in step 214 simply to a single remote host. Upon installation, step 216 proceeds to derive a secure identifier in the data storage device with the handshake module. Because the initial installation of the storage device ensures a secure provenance, the secure identifier can be generated from the TPM of the remote host/system. The generation of the secure identifier corresponds with a trusted connection between the data storage device and the system/host.

The trusted connection prompts the data storage device to update a connection count in step 218 and update the in-device provenance log in step 220. It is noted that the storage device provenance may log additional information to the number of secure system connections, such as firmware versions, power cycles, and number of identifiers created from system TPMs. The trusted connection allows the lock circuit of the data storage device to lock the device to the system/host by requiring the secure identifier, and/or a derivation thereof, to accompany any request for storage device access or control.

Operation of the data storage device can continuously, or sporadically, occur for any amount of times to service any number of data access requests over time. During operation, decision 224 evaluates if a power cycle occurs. Upon boot and initialization from a power cycle, step 226 then compares the secure identifier of the storage device to a key supplied by the connected system/host. If the key matches the secure identifier, the storage device can confidently form another trusted connection with that system/host in step 228. However, if the supplied key does not match the secure identifier, the storage device refuses connection, access, and control. As such, the data storage device, due to the in-device provenance, can verify a trusted remote host/system or identify and refuse an untrusted remote host/system.

At any time during the formation, or re-formation, of a trusted connection, the data storage device may be intentionally removed from the system/host with the intention of being installed in another system. Decision 230 evaluates if such an intentional removal is imminent or planned. Step 232 engages the handshake module of the data storage device to remove the secure identifier as a requirement for storage device access and control in response to a valid detach trigger. In the event no trusted connection detachment is called for, decision 230 returns to step 222 and/or decision 224 to conduct data access activity to service a system/host.

It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present technology to the full extent indicated by the broad general meaning of the terms in which the appended claims are expressed. For example, the particular elements may vary depending on the particular application without departing from the spirit and scope of the present disclosure.

What is claimed is:

1. An apparatus comprising
a storage device encoded with a key certificate, the data storage device initialized into a distributed data system;
a handshake module of the data storage device to derive a secure identifier;
a provenance module of the data storage device to monitor data storage device activity and maintain an in-device provenance; and
a trusted data pathway between the data storage device and a host of the distributed data storage system formed with the secure identifier.

2. The apparatus of claim 1, wherein the handshake module and provenance module are each resident in a housing of the data storage device.

3. The apparatus of claim 1, wherein the handshake module comprises a lock circuit to execute at least one protection policy to prevent access to the data storage device by a third party.

4. The apparatus of claim 1, wherein the handshake module comprises a trust circuit to establish and maintain the trusted data pathway.

5. The apparatus of claim 1, wherein the handshake module comprises a hash circuit to derive the secure identifier with a device key and a secure trusted platform module.

6. A method comprising:
encoding a storage device with a key certificate;
initializing the data storage device into a distributed data system;
deriving a secure identifier with a handshake module of the data storage device, the secure identifier;
monitoring data storage device activity with a provenance module of the data storage device to maintain an in-device provenance; and
utilizing the secure identifier to form a trusted relationship with a host of the distributed data storage system.

7. The method of claim 6, wherein the provenance module authenticates data within the data storage device to maintain the in-device provenance.

8. The method of claim 7, wherein the data is authenticated by testing a previous source and destination for data.

9. The method of claim 6, wherein the provenance module authenticates the data storage device by maintaining a provenance log of connections to the data storage device.

10. The method of claim 6, wherein the secure identifier is derived using a cryptographic function to combine the key certificate and a security data of the data storage device to generate a hash value.

11. The method of claim 10, wherein the hash value is employed during a subsequent initialization of communications between the storage device and the host.

12. The method of claim 6, wherein the key certificate is unique to the data storage device.

13. The method of claim 10, wherein the key certificate is encoded by a manufacturer prior to user data being stored on the data storage device.

14. The method of claim 12, wherein the key certificate is generated from operational metrics during manufacturer testing.

15. The method of claim 14, wherein the operational metric is read latency.

16. The method of claim 14, wherein the operational metric is measured fly height.

17. The method of claim 10, wherein the provenance module monitors a number and source of data connections in a log over time to maintain the in-device provenance.

18. A method comprising:
encoding a storage device with a key certificate;
initializing the data storage device into a distributed data system;
deriving a secure identifier with a handshake module of the data storage device;
monitoring data storage device activity with a provenance module of the data storage device to maintain an in-device provenance;
utilizing the secure identifier to form a trusted relationship with a host of the distributed data storage system;
detecting an imminent detachment of the data storage device from the distributed data system; and
removing the secure identifier as a requirement for data storage device access and control with the handshake module.

19. The method of claim 18, wherein a detach circuit of the provenance module removes the secure identifier to terminate the trusted relationship with the host and enable a new trusted relationship to be created.

20. The method of claim 18, wherein the handshake module allowing a single trusted relationship between the data storage device and host.
